(19) United States
(12) Patent Application Publication
(10) Pub. No.: US 2011/0031731 A1
(43) Pub. Date: Feb. 10, 2011

(54) BOOK-CLIP

(76) Inventor: Christian Julian Popowich, Calgary (CA)

Correspondence Address: Christian J. Popowich, 517 Sunderland Avenue S.W., Calgary, AB, T3A 2K5, CA

(21) Appl. No.: 12/535,664

(22) Filed: Aug. 4, 2009

(51) Int. Cl. B42D 9/00

(52) U.S. Cl. 281/42

(57) ABSTRACT

A small clip to hold open a book, conveniently remaining in it as a marker when closed, which is unobtrusive and inexpensively made. It is a single piece metal or plastic frame consisting of a straddle plate (11) and a breech (12) which are joined and spaced apart and parallel by a bridge (13). The combination of the elements forms a housing for several pages of a book when clipped over them. When slid so that the straddle crosses the centre of an open book and the breech is near the spine (between pages below), the present invention holds open the book. When placed so that the straddle is on one page only and the breech is several pages below, the book may be closed and so marked and the clip stored.

### BACKGROUND

1. Field of the Invention

The present invention relates to a retainer for holding open a book and marking a page when closed, called a book-clip.

2. Description of Prior Art

Various devices are known to hold open books or clip their pages, but to the best of my knowledge there is no prior art book holder or retainer or clip that is as simple, small and unobtrusive, easy to use, and unrestricted in use, inexpensive and easy to construct, as the present invention, or which like it is stored within and as a book mark, and also may receive advertising or art.

In certain types, the whole of an open book is placed in a holder of some sort and held in place by any number of methods. One such is an upright holder which rests on a counter and holds open the book by housing it. Another is a table with various mechanical arms or elements to hold the book in place. These and related holders have several disadvantages. They are relatively large and often must stand on a flat surface. They often cover part of the text and require some form of adjustment so that the text may be read. They are relatively awkward to use, requiring several motions. Some function only for a pre-determined size of book. They may not be used as a marker when the book is closed, or be thereby conveniently stored also. Nor are they receptive or advertising or art.

An example of such a device is described and illustrated in U.S. Pat. No. 5,364,056, dated Nov. 15, 1994, granted to Jiang for a “Combined book holder and bookmark”. While it holds open a book and marks a page when closed, it has several disadvantages. The size of the book which can be held is limited to less than the length and width of the device. It is relatively large and cumbersome to use. It may cover text when holding open a book. A flat surface is needed to support it. It has moving parts subject to wear and tear. Construction requires manufacture and assembly of several parts. And it cannot be used with a single motion.

Another example of such a device is described and illustrated in U.S. Pat. No. 6,019,339, dated Feb. 1, 2000, granted to Brayford for a “Book Holder”. While it holds open a book, it has most of the same disadvantages; and as with other “Bookholders”, it does not mark a page in a closed book and is relatively large.

Another example of such a device to hold open a book is described and illustrated in U.S. Pat. No. 6,733,043, dated May 11, 2004, to Silverstein for a “Bookholder”. It has most of the same disadvantages, and the book must be laid flat for the device to work.

In other types, two elements are inserted between pages on either side of the spine. They are awkward to use and obstruct text.

An example of such a device to hold open a book is described and illustrated in U.S. Pat. No. 4,932,680, dated Jun. 12, 1990, granted to Rivera for a “Book clip”. While it holds open a book, it has several disadvantages. It is awkward and relatively difficult to use in that two elements must be simultaneously inserted between pages on both sides of an open book, requiring significant manipulation and sometimes snagging. It draws the pages of an open book together at the centre, such that not all of the text is visible. It covers part of the text and must be moved to permit reading of the entire page. It is large and cannot be conveniently used as a bookmark. It must be used with the book in a standing position, not laying, and it cannot provide a means for advertising.

Another example of such a device to hold open a book is described and illustrated in U.S. Pat. No. 322,459, dated Dec. 17, 1991, to Pimienta for an “ornamental design for a book clip”. While it holds open a book, it also has most of the same disadvantages. The requirement to insert two elements in the pages below make it awkward to use. It covers text. It has been found not to work effectively at the starting or ending pages of the book. And it is again relatively large.

Another example of such a device to hold open a book is described and illustrated in U.S. Pat. No. 6,537,796, dated Mar. 19, 2002, to Halstead for a “smooth book clip”. It suffers also from most of the same disadvantages, and is not receptive of art or advertising.

Another type of device to hold open a book is some form of weight, such as a leather oblong with lead stitched into it which is laid across the pages of an open book. It also has several disadvantages. It covers the text and must be moved so that covered parts can be read. It can only be used when the book is lying flat. It is of course relatively heavy. It does not store with the book, which leads it to be easily misplaced.

And other unsuitable devices, most often intended for other purposes, have been used to hold open a book: paperweights, staplers, tape holders, books, ashtrays, dishes etc. These have some or all of the disadvantages of the above-noted types.

### Objects and Advantages

It is desirable to have a device to hold open books which is used with a single motion, is small and unobtrusive, is stored in the book and marks a page, allows the book to be stood on end, held or laid in a flat position, and is inexpensive to make and therefore purchase. The present invention provides these advantages and overcomes the disadvantages of the prior art.

The present invention is a small rigid metal (or other material) device which straddles the opposing pages of an open book and in a single motion is clipped over several leaves of the book by means of a breech and bridge to keep it in place, thereby holding open the book, and which remains as a marker in the book when closed.

The present invention has one element to be inserted within the pages of an open book, and so can be readily and easily used in a single motion with the book in virtually any position. It is unobtrusive and does not cover the book's text. Text or art may be put on it for advertising or esthetics. And the device functions on all manners of books.

### DRAWING FIGURES

The present invention, as exemplified by a preferred embodiment, is described with reference to the Drawings in which:

FIGS. 1 and 2 show perspective views of the obverse and reverse sides of the book-clip;

FIGS. 3 and 4 show the book-clip holding open a book and remaining in it as a marker when closed.

### REFERENCE NUMERALS

In the Drawings, the following reference numerals are used:

11 Straddle

12 Breech

13 Bridge

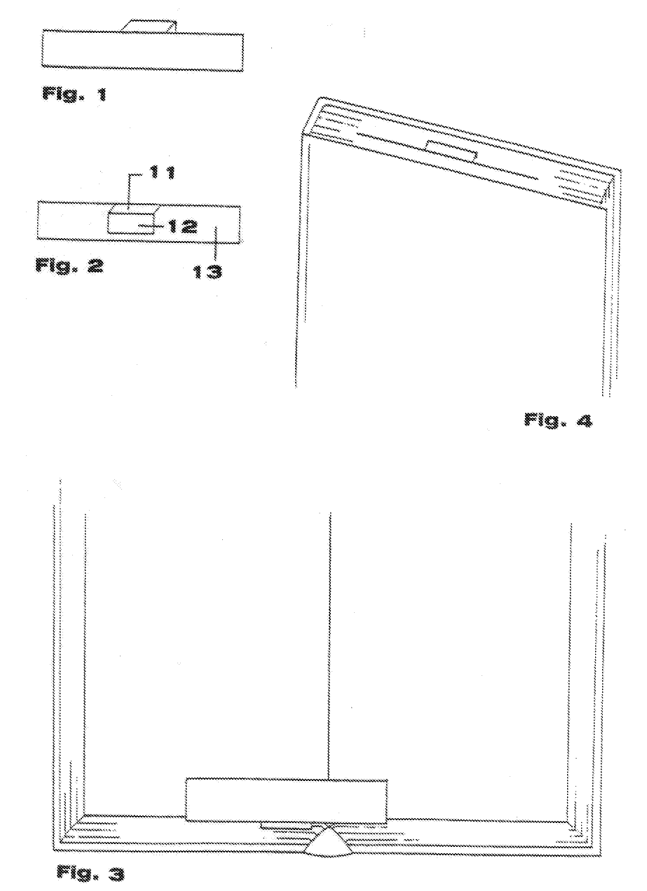

### DESCRIPTION OF INVENTION—FIGS. 1 AND 2

The present invention comprises a frame, having a straddle plate 11 and breech 12 parallel thereto which is spaced from and spanned by a bridge 13.

The straddle crosses the centre of an open book and is held on the open pages by the breech, inserted several leaves below and placed near the spine. The breech is parallel to and spaced apart from the straddle plate at a distance sufficient to sandwich and house several leaves between the inner sides of the breech and straddle plate. The breech and straddle plate are joined by a bridge, which spans the edges of a book's leaves so housed.

The present invention may be made of thin sheet metal which can be cut or stamped and bent into the shape of the device and remains sufficiently rigid. The present invention may also be made of thin plastic which can be moulded, extruded, cut and bent, or otherwise made rigidly into the shape and form of the device. It may also be made of other materials having suitable properties, such as polyethylene, polypropylene, vinyl, nylon, various impregnated or laminated fibrous materials, various plasticized materials, cardboard, etc.

Although only a single embodiment of the present invention has been described and illustrated, the present invention is not limited to the features of this embodiment. There are various additional possibilities with regard to: the relative disposition of the bridge and breech to the straddle; the sizes and shapes of the straddle, bridge, and breech (or extensions thereof); and of the method of joining the straddle, bridge and breech (as by spring, for example); and of the material(s) of manufacture and texture thereof.

### OPERATION OF INVENTION—FIGS. 3 AND 4

The present invention is operated by (1) clipping several leaves of one side of an open book, top or bottom, between the straddle and breech, and (2) then sliding it so that the straddle crosses the book's centre and is held on the open pages by the breech, inserted several leaves below and placed near the binding. The book will then remain open because the opposing pages are held down and apart by the straddle, and the straddle is held secure from lifting by the breech which is several leaves below.

FIG. 3 is of the present invention holding open a book.

The book and its leaves are released for turning by lifting off the device. The book may be closed by sliding the device back across the centre so that it is on one side only. It may remain in the book when closed, marking the page and being ready at hand.

FIG. 4 is of the present invention remaining in a closed book as a marker.

The present invention has been found to function effectively with all manner of books, irrespective of construction or size.

Another feature of this invention is that text or art may be put on its face for esthetic purposes, advertisement, identification etc.

I claim:

1. A device for holding open a book and remaining in it as a marker when closed, comprising:
a transverse straddle;
a breech spaced apart and parallel thereto; and
a bridge to span and join the straddle and breech which forms a housing for several leaves of a book and thus a retainer for an open book when positioned so that the straddle is across the book's centre and the breech is several leaves below near the spine, as well as a marker when positioned on one side only of a closed book, made of thin rigid material.

2. The device of claim 1, the Straddle or breach of which are arced or otherwise shaped for increased functionality.

3. The device of claim 1, to the inner sides or edges of which have been applied a coating or material, such as latex or rubber, for increased functionality.

4. The device of claim 1, the inner sides or edges of which are textured or formed for increased functionality.
